(19) United States
(12) Patent Application Publication
(10) Pub. No.: US 2026/0245370 A1
(43) Pub. Date: Aug. 20, 2026

(54) MONITORING METHOD USING THERMAL IMAGE AND DEVICE USING THE SAME

(71) Applicant: NEXTCHIP Co., Ltd., Gyeonggi-do (KR)

(72) Inventor: E-woo CHON, Seoul (KR)

(21) Appl. No.: 19/535,350

(22) Filed: Feb. 10, 2026

(30) Foreign Application Priority Data
Feb. 19, 2025 (KR) 10-2025-0021704

(51) Int. Cl. G06V 20/52; G06V 10/14; G06V 10/764; G06V 20/59; G06V 40/10

(52) U.S. Cl. CPC G06V 20/52; G06V 10/14; G06V 10/764; G06V 20/59; G06V 40/10

(57) ABSTRACT

A monitoring method performed in a monitoring device using a thermal image generated by a thermal image camera, comprising: determining, by the monitoring device, whether a pixel value of each pixel scanned in the thermal image is included in a preset reference range; classifying, by the monitoring device, pixel regions by assigning a classification number to pixels included in the reference range according to a predetermined rule; calculating, by the monitoring device, a total number of pixels for the classified pixel regions; recognizing, by the monitoring device, an object for a heat source included in image data based on the total number of pixels and a preset object reference value; and generating, by the monitoring device, a control signal by using object information of the recognized object and sensing data for a space imaged by the thermal image camera.

### CROSS-REFERENCE TO RELATED APPLICATION

This application claims priority under 35 U.S.C §119 to Korean Patent Application No. 10-2025-0021704 filed on February 19, 2025, in the Korean Intellectual Property Office, the entire contents of which are hereby incorporated by reference.

### BACKGROUND OF THE INVENTION

### Field of the Invention

The present disclosure relates to a monitoring method using a thermal image and a device using the same. More specifically, the present disclosure relates to a monitoring method using a thermal image and a device using the same, which recognize an object from a thermal image generated by a thermal image camera and control a space imaged by the thermal image camera and the recognized object.

### Description of the Related Art

The content described in this section merely provides background information for the present embodiment and does not constitute prior art.

A thermal image camera is a device that detects heat (infrared radiation) emitted from an object by using an infrared sensor and converts the detected heat into a visual image (thermal image).

A process of recognizing an object from image data generated by using the thermal image camera involves a large amount of computational processing, thereby increasing a computational load and causing a decrease in processing speed, which results in a problem in deriving result data through real-time analysis.

Accordingly, there is a need to optimize a method of recognizing an object from image data generated by the thermal image camera.

### SUMMARY OF THE INVENTION

An aspects of the present disclosure is to provide a monitoring method for a thermal image generated by a thermal image camera and a device using the same, which optimize a method of recognizing an object from a thermal image generated by the thermal image camera to reduce a computational load and generate a control signal for an object recognized in real time.

An aspects of the present disclosure are not limited to the objects described above, and other objects and advantages of the present disclosure that are not mentioned may be understood by the following description and will be more clearly understood by embodiments of the present disclosure. In addition, it will be readily understood that the objects and advantages of the present disclosure may be realized by means indicated in the claims and combinations thereof.

According to some aspects of the present disclosure, there is a monitoring method performed in a monitoring device using a thermal image generated by a thermal image camera, comprising: determining, by the monitoring device, whether a pixel value of each pixel scanned in the thermal image is included in a preset reference range; classifying, by the monitoring device, pixel regions by assigning a classification number to pixels included in the reference range according to a predetermined rule; calculating, by the monitoring device, a total number of pixels for the classified pixel regions; recognizing, by the monitoring device, an object for a heat source included in image data based on the total number of pixels and a preset object reference value; and generating, by the monitoring device, a control signal by using object information of the recognized object and sensing data for a space imaged by the thermal image camera.

According to some aspects, the classifying the pixel regions includes assigning a natural number as a classification number to a pixel when a pixel value of each scanned pixel corresponds to a first case in which the pixel value is included in the preset reference range; and assigning a classification number of “0” or a “null” value to a pixel when a pixel value of each scanned pixel corresponds to a second case in which the pixel value is not included in the preset reference range.

According to some aspects, the preset reference range includes an upper reference value and a lower reference value, and wherein the classifying the pixel regions includes assigning a classification number to a pixel having a pixel value that is less than the upper reference value and greater than the lower reference value.

According to some aspects, the classifying the pixel regions includes when a target pixel to be scanned corresponds to the first case, assigning a classification number to the target pixel based on a first classification number of a first pixel adjacent to a left side of the target pixel and a second classification number of a second pixel adjacent to an upper side of the target pixel.

According to some aspects, the classifying the pixel regions includes when both the first classification number and the second classification number are natural numbers, assigning the second classification number to the target pixel and replacing the first classification number with the second classification number; when the first classification number is not a natural number and the second classification number is a natural number, assigning the second classification number to the target pixel; and when the first classification number is a natural number and the second classification number is not a natural number, assigning the first classification number to the target pixel.

According to some aspects, the method may further include the classifying the pixel regions when both the first classification number and the second classification number are not natural numbers, assigning a classification number different from a currently used classification number to the target pixel.

According to some aspects, the calculating the total number of pixels includes when a first pixel region to which a first classification number is assigned and a second pixel region to which a second classification number is assigned are adjacent to each other, merging the first pixel region and the second pixel region; and recognizing an object for a heat source by calculating a total number of pixels included in the merged pixel region and comparing the calculated total number of pixels with a preset object reference value.

According to some aspects, the recognizing the object for the heat source includes recognizing the pixel region as an adult object when the total number of pixels for the pixel region is greater than a preset first reference value; and recognizing the pixel region as a child object when the total number of pixels for the pixel region is less than the preset first reference value and greater than a second reference value different from the first reference value.

According to some aspects, the method may further include the recognizing the object for the heat source determining that an object corresponding to the pixel region is absent when the total number of pixels for the pixel region is less than the second reference value.

According to some aspects of the present disclosure, there is A monitoring device using a thermal image, the device including: a processor; a memory configured to load a computer program executed by the processor; and an interface configured to exchange data generated during execution of the computer program with an external device, wherein the computer program includes: determining whether a pixel value of each pixel scanned in a thermal image received from a thermal image camera is included in a preset reference range; classifying pixel regions by assigning a classification number to pixels included in the reference range according to a predetermined rule; calculating a total number of pixels for the classified pixel regions; recognizing an object for a heat source included in image data based on the total number of pixels and a preset object reference value; and generating a control signal by using object information of the recognized object and sensing data for a space imaged by the thermal image camera.

According to some aspects, in the computer program, the classifying the pixel regions includes: assigning a natural number as a classification number to a pixel when a pixel value of each scanned pixel corresponds to a first case in which the pixel value is included in the preset reference range; and assigning a classification number of “0” or a “null” value to a pixel when a pixel value of each scanned pixel corresponds to a second case in which the pixel value is not included in the preset reference range.

According to some aspects, in the computer program, the classifying the pixel regions includes: when a target pixel to be scanned corresponds to the first case, assigning a classification number to the target pixel based on a first classification number of a first pixel adjacent to a left side of the target pixel and a second classification number of a second pixel adjacent to an upper side of the target pixel.

According to some aspects, in the computer program, the classifying the pixel regions includes: when both the first classification number and the second classification number are natural numbers, assigning the second classification number to the target pixel and replacing the first classification number with the second classification number; when the first classification number is not a natural number and the second classification number is a natural number, assigning the second classification number to the target pixel; when the first classification number is a natural number and the second classification number is not a natural number, assigning the first classification number to the target pixel; and when both the first classification number and the second classification number are not natural numbers, assigning a classification number different from a currently used classification number to the target pixel.

According to some aspects, the sensing data include a temperature and humidity of the space and an external temperature and external humidity of the space, and wherein, in the computer program, the step of generating the control signal includes: generating a first control signal for controlling the temperature and humidity of the space based on the number of objects of the object information and the sensing data.

According to some aspects, the thermal image camera is installed in a vehicle and images an inside of the vehicle, wherein the sensing data include whether the vehicle is in operation and whether a door of the vehicle is locked, and wherein, in the computer program, the step of generating the control signal includes: identifying operation of the vehicle based on the sensing data and generating a second control signal for controlling operation of the vehicle based on the operation and the object information; providing an object detection notification to a pre-registered user terminal by identifying a stopped state of the vehicle and a locked state of the door of the vehicle based on the sensing data; or generating a third control signal for performing an operation preset by a user by identifying a stopped state of the vehicle and an open state of the door of the vehicle based on the sensing data.

According to an embodiment of the present disclosure, a monitoring method using a thermal image and a device using the same may secure safety of an object by generating a control signal based on real-time monitoring of a recognized object by optimizing a process of recognizing the object from the thermal image.

In addition to the above-described content, specific effects of the present disclosure will be described together while describing detailed matters for carrying out the invention below.

### BRIEF DESCRIPTION OF THE DRAWINGS

FIG. 1 is a system block diagram for monitoring thermal images for describing a monitoring device using a thermal image according to some embodiments of the present disclosure.

FIG. 2 is a view for describing a thermal image generated by the thermal image camera of FIG. 1.

FIG. 3 is a flowchart for describing a monitoring method using a thermal image according to some embodiments of the present disclosure.

FIG. 4 is a view for describing pixel regions classified in step S200 of FIG. 3.

FIG. 5 is a flowchart for describing classification numbers assigned to the classified pixel regions of FIGS. 3 and 4.

FIGS. 6 and 7 are views for describing predetermined rules for assigning classification numbers in FIG. 5.

FIGS. 8 to 10 are views for describing classification numbers assigned to the thermal image of FIG. 4 according to the predetermined rules of FIGS. 6 and 7.

FIG. 11 is a view for describing object recognition of step S300 of FIG. 3.

FIG. 12 is a view for describing an object reference value of step S330 of FIG. 11.

FIG. 13 is a view for describing a first embodiment in which the control module of FIG. 1 operates step S400 of FIG. 3.

FIG. 14 is a view for describing a second embodiment in which the control module of FIG. 1 operates step S400 of FIG. 3.

FIG. 15 is a view for describing a hardware implementation of a monitoring device using a thermal image that performs a monitoring method using a thermal image according to some embodiments of the present disclosure.

### DETAILED DESCRIPTION OF THE DISCLOSURE

The terms or words used in the disclosure and the claims should not be construed as limited to their ordinary or lexical meanings. They should be construed as the meaning and concept in line with the technical idea of the disclosure based on the principle that the inventor can define the concept of terms or words in order to describe his/her own inventive concept in the best possible way. Further, since the embodiment described herein and the configurations illustrated in the drawings are merely one embodiment in which the disclosure is realized and do not represent all the technical ideas of the disclosure, it should be understood that there may be various equivalents, variations, and applicable examples that can replace them at the time of filing this application.

Although terms such as first, second, A, B, etc. used in the description and the claims may be used to describe various components, the components should not be limited by these terms. These terms are only used to differentiate one component from another. For example, a first component may be referred to as a second component, and similarly, a second component may be referred to as a first component, without departing from the scope of the disclosure. The term ‘and/or’ includes a combination of a plurality of related listed items or any item of the plurality of related listed items.

The terms used in the description and the claims are merely used to describe particular embodiments and are not intended to limit the disclosure. Singular forms are intended to include plural forms unless the context clearly indicates otherwise. In the application, terms such as “comprise,” “comprise,” “have,” etc. should be understood as not precluding the possibility of existence or addition of features, numbers, steps, operations, components, parts, or combinations thereof described herein.

Unless being defined otherwise, all terms used herein, including technical or scientific terms, have the same meaning as commonly understood by those skilled in the art to which the disclosure pertains.

Terms such as those defined in commonly used dictionaries should be construed as having a meaning consistent with the meaning in the context of the relevant art, and are not to be construed in an ideal or excessively formal sense unless explicitly defined in the application.

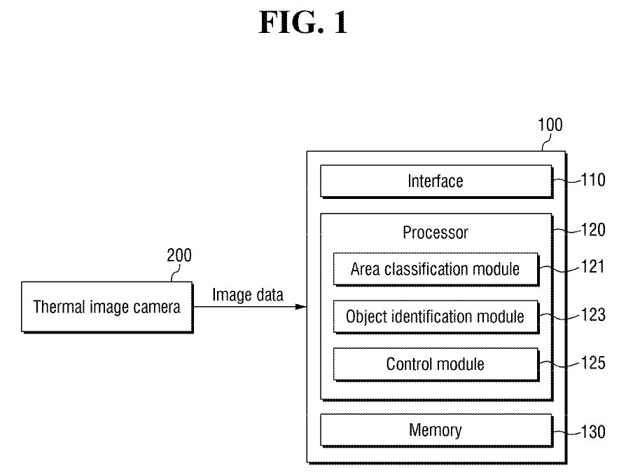

Hereinafter, a monitoring method using a thermal image of a monitoring device using a thermal image according to some embodiments of the present disclosure will be described with reference to FIGS. 1 to 15.

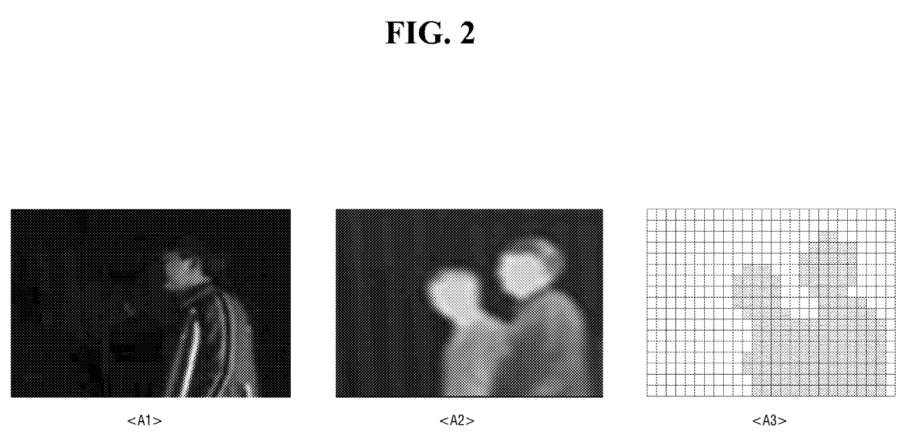

FIG. 1 is a system block diagram for monitoring thermal images for describing a monitoring device using a thermal image according to some embodiments of the present disclosure. FIG. 2 is a view for describing a thermal image generated by the thermal image camera of FIG. 1.

Referring to FIG. 1, a system for monitoring thermal images according to some embodiments of the present disclosure includes a monitoring device using a thermal image 100 (hereinafter referred to as a monitoring device) and a thermal image camera 200.

The monitoring device 100 may identify an object by receiving image data generated by the thermal image camera 200 and may generate a control signal corresponding to the identified object.

Referring to FIG. 2 together, an optical camera may generate an image obtained by imaging a subject by detecting visible light, as shown in <A1> of FIG. 2. The thermal image camera 200 may generate image data output as a digital image or an analog image by detecting thermal energy of a subject by using a thermal imaging sensor, as shown in <A2> of FIG. 2. For example, the image data may include an image including a plurality of thermal images.

The monitoring device 100 may provide a control signal generated in correspondence with a recognized object from the provided image data to an external device. An external device may be used by an administrator and may refer to a communication terminal capable of operating an application in a wired or wireless communication environment. The external device may include, for example, various types of electronic devices such as a personal computer PC, a notebook computer, a tablet, a mobile phone, a smartphone, a wearable device (for example a watch-type terminal), and a communication module of a vehicle, and the like. In addition, the external device does not refer to one specific terminal, but may be used as a term collectively referring to various electronic devices used by the administrator.

Hereinafter, each module of the monitoring device 100 according to some embodiments of the present disclosure will be described in detail.

Referring to FIG. 1, the monitoring device 100 according to some embodiments of the present disclosure includes an interface 110, a processor 120, and a memory 130.

The processor 120 may drive or execute an area classification module 121, an object identification module 123, and a control module 125.

At this time, each module may be stored and used in a form of a computer program in a database (not shown) included in the monitoring device 100 or in the memory 130. In some embodiments of the present disclosure, some of the above-described modules may be omitted or may be replaced with other modules.

Specifically, the interface 110 may transmit data received by the monitoring device 100 from the thermal image camera 200 to other components in the monitoring device 100. The interface 110 is provided in the monitoring device 100 and may be connected to an input and output device for receiving an input from the administrator. In addition, the interface 110 may include various communication modules and may perform data exchange with an external device through a communication network.

The communication network performs a role of connecting the monitoring device 100 and at least one external device. That is, the communication network refers to a communication network that provides an access path so that an external device may transmit and receive data after accessing the monitoring device 100. The communication network may include, for example, wired networks such as local area networks (LANs), wide area networks (WANs), metropolitan area networks (MANs), integrated service digital networks (ISDNs), and the like, or wireless networks such as wireless LANs, code division multiple access (CDMA), Bluetooth, satellite communication, and the like, but the scope of the present disclosure is not limited thereto.

The processor 120 may execute software to control at least one other component of the monitoring device 100, such as a hardware component or a software component, and may perform various data processing and operations. For example, the processor 120 may load information, commands, or data received from another component, such as the memory 130, into an internal memory, perform operations by using the loaded information, commands, or data, and store result data according to the operations in a database or a storage (not shown). At this time, the processor 120, as a subject that performs operations, may read required commands from the memory 130 and perform specific functions according to a predefined program.

The memory 130 may load and store various data used by at least one component of the monitoring device 100, such as the processor 120. For example, the data may include input data or output data for software and commands related thereto. That is, the memory 130 refers to a recording medium or a storage device that stores software modules, instruction sets, and the like required for system operations of the present disclosure.

Accordingly, the processor 120 may read and use modules or instructions related to various operations of a monitoring method using a thermal image according to some embodiments of the present disclosure from the memory 130.

Hereinafter, operations of each module executed by the processor 120 will be described.

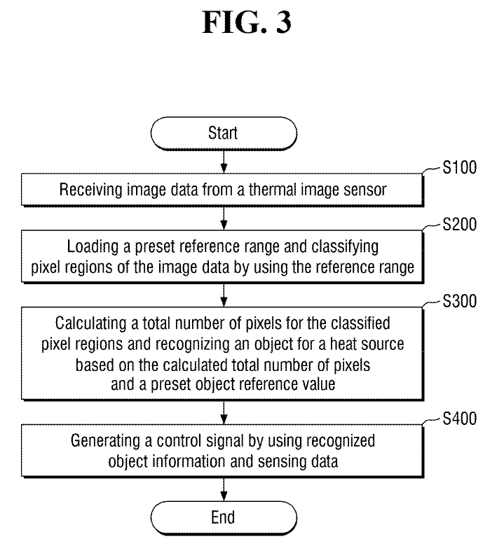

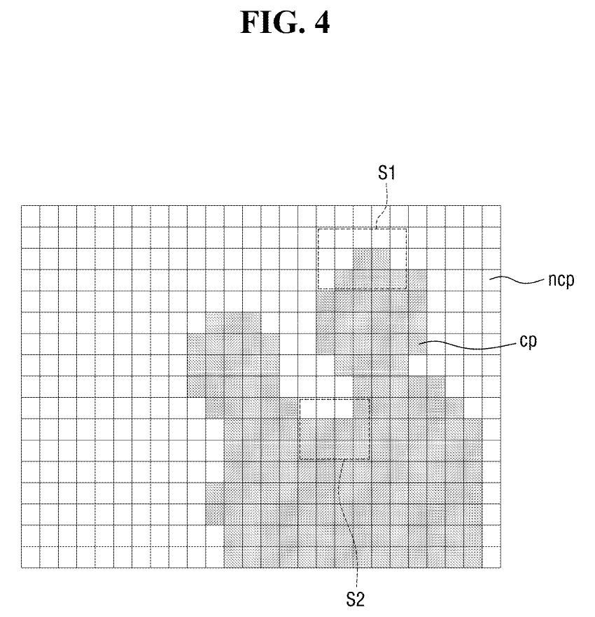

First, the area classification module 121 may classify pixel regions to which classification numbers are assigned and pixel regions to which classification numbers are not assigned in image data provided by the thermal image camera. A detailed description thereof will be described later in detail with reference to FIGS. 3 and 4.

The object identification module 123 may assign classification numbers to pixels of the image data whose regions are classified by the area classification module 121 and may recognize an object corresponding to a heat source included in the image data based on the assigned classification numbers. A detailed description thereof will be described later in detail with reference to FIGS. 3 and 5 to 12.

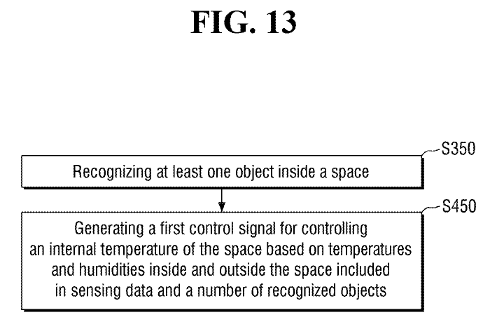

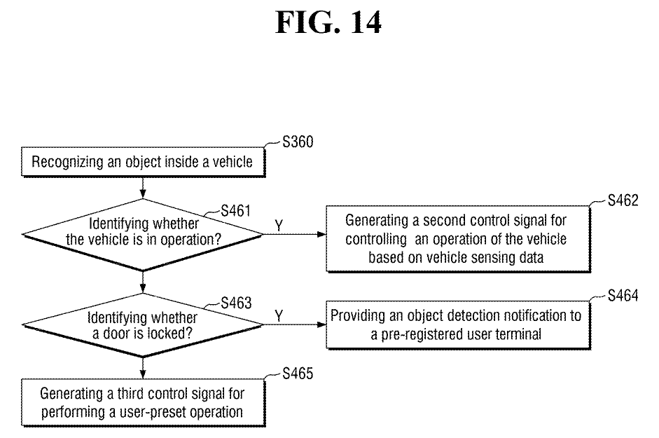

Subsequently, the control module 125 may generate a control signal by using object information of an object recognized by the object identification module 123 and sensing data for a space imaged by the thermal image camera. A detailed description thereof will be described later in detail with reference to FIGS. 13 and 14.

Hereinafter, a monitoring method using a thermal image according to some embodiments of the present disclosure will be described in detail with reference to FIGS. 3 to 14.

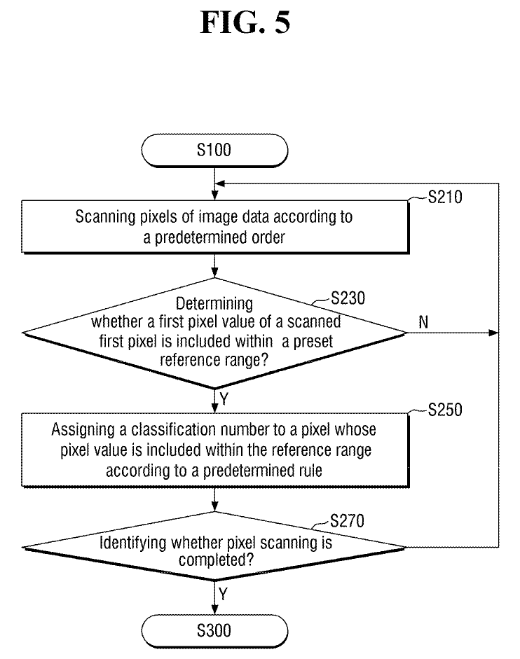

FIG. 3 is a flowchart for describing a monitoring method using a thermal image according to some embodiments of the present disclosure. FIG. 4 is a view for describing pixel regions classified in step S200 of FIG. 3. FIG. 5 is a flowchart for describing classification numbers assigned to the classified pixel regions of FIGS. 3 and 4. Hereinafter, it will be described by taking as an example that a subject performing the monitoring method using a thermal image of the present disclosure is the monitoring device 100 or the processor 120.

Referring to FIG. 3, the monitoring device 100 may receive image data from the thermal image camera 200 (S100). For example, referring to FIG. 2 together, the processor 120 may receive image data through the interface 110 that receives image data (<A2> of FIG. 2) from the thermal imaging sensor.

Subsequently, the monitoring device 100 may load a preset reference range and may classify pixel regions of the image data by using the loaded reference range by using the area classification module 121 loaded on the memory 130 (S200). For example, the processor 120 may classify regions by determining whether a pixel value of each pixel scanned in a thermal image of the image data is included in the preset reference range. Referring to <A3> of FIG. 2, the classified regions may be regions classified based on whether a pixel value of each pixel is included in a preset reference range. The preset reference range may include an upper reference value and a lower reference value. Accordingly, the processor 120 may primarily classify regions by assigning a classification number to pixels having a pixel value less than the upper reference value and greater than the lower reference value.

Referring to FIG. 5, the processor 120 may scan pixels of the image data according to a predetermined order (S210). For example, the predetermined order may include a raster scan and a progressive scan. However, this description is merely exemplary, and embodiments of the present disclosure are not limited thereto. The predetermined order may include other methods of scanning pixels of the image data.

Subsequently, the processor 120 may determine whether a pixel value of a scanned pixel is included in the preset reference range (S230). For example, referring to FIG. 4 together, when a first pixel value of a scanned first pixel corresponds to a first case cp in which the first pixel value is included in the preset reference range, the processor 120 may assign a classification number of a natural number to the corresponding pixel.

In contrast, when a pixel value of each pixel scanned in the thermal image corresponds to a second case ncp in which the pixel value is not included in the preset reference range, the processor 120 may assign a classification number of 0 or a null value to the corresponding pixel.

That is, the processor 120 may classify regions corresponding to a first case cp and a second case ncp, respectively, based on whether a pixel value of each of the pixels of a thermal image is included in a preset reference range.

When a pixel value of a scanned pixel corresponds to the second case ncp, the processor 120 may identify whether pixel scanning has been completed (S270). At this time, when the pixel scanning has not been completed, the processor 120 may scan a next pixel according to a predetermined order (S210).

When a pixel value of a scanned pixel corresponds to the first case cp, the processor 120 may assign a classification number to a pixel whose pixel value is included in the reference range according to a predetermined rule (S250). For example, when a target pixel to be scanned corresponds to the first case, the processor 120 may assign a classification number to the target pixel based on a first classification number of a first pixel adjacent to a left side of the target pixel and a second classification number of a second pixel adjacent to an upper side of the target pixel.

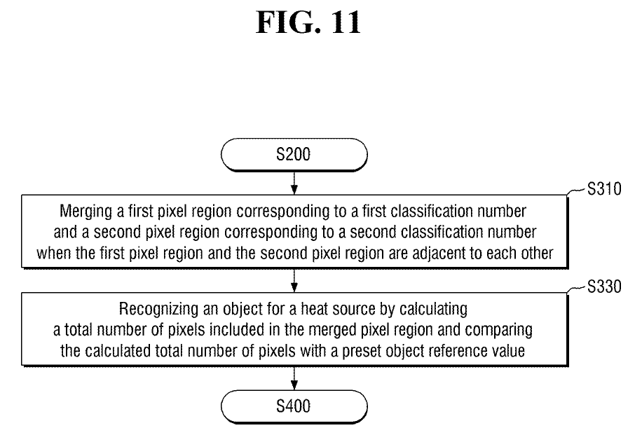

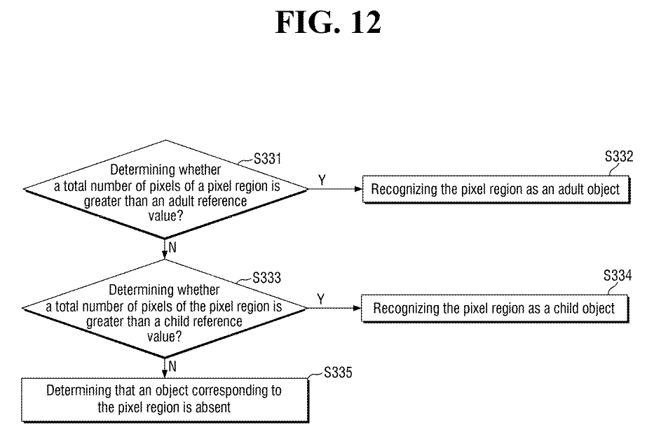

Subsequently, the processor 120 may identify whether the pixel scanning has been completed (S270). When the pixel scanning is not completed, the processor 120 may continuously scan a next pixel according to the predetermined order (S210). When the pixel scanning is completed, the processor 120 may recognize an object corresponding to a heat source based on the assigned classification numbers and a total number of pixels to which the classification numbers are assigned (S300). A detailed method for object recognition will be described later in detail with reference to FIGS. 11 and 12.

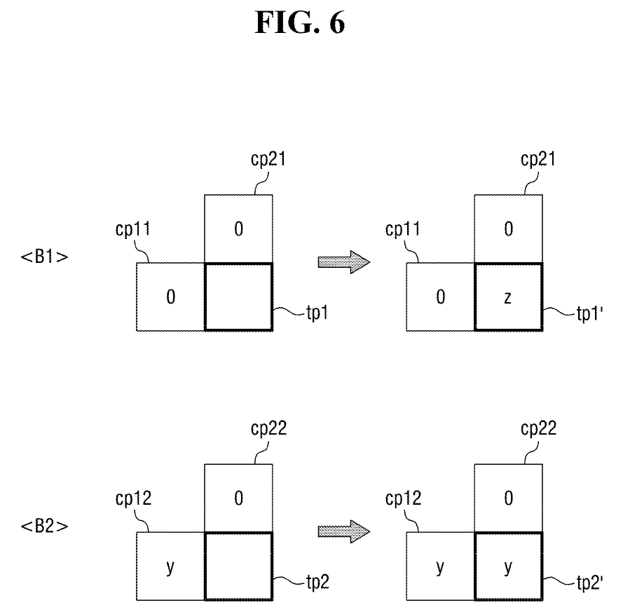

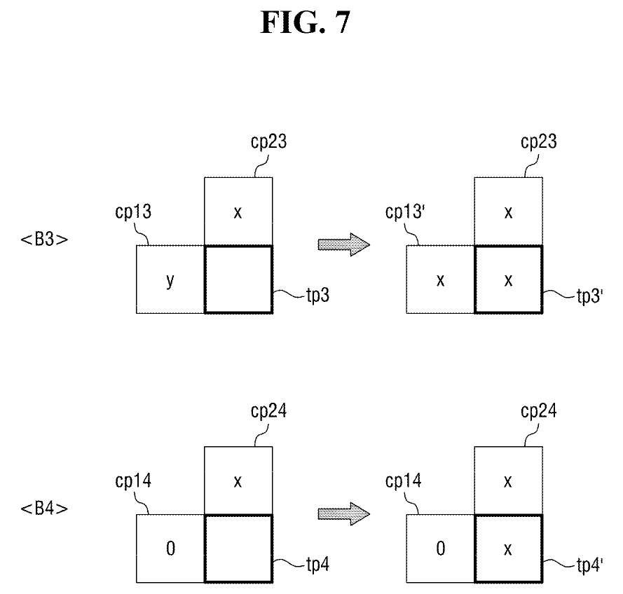

Hereinafter, the predetermined rules will be described with reference to FIGS. 6 and 7. For convenience of description, a target pixel to be scanned is defined as a pixel corresponding to the first case. In addition, a pixel adjacent to a left side of the target pixel to be scanned is defined as a first pixel, and a pixel adjacent to an upper side of the target pixel to be scanned is defined as a second pixel.

FIGS. 6 and 7 are views for describing predetermined rules for assigning classification numbers in FIG. 5.

Referring to <B1> of FIG. 6, when both a first classification number of the first pixel and a second classification number of the second pixel are not natural numbers, the processor 120 may assign a classification number different from a currently used classification number to the target pixel.

At this time, the processor 120 may update a reference of the currently used classification number to the newly assigned different classification number.

In addition, referring to <B2> of FIG. 6, when the first classification number is a natural number and the second classification number is not a natural number, the processor 120 may assign the first classification number to the target pixel.

Referring to <B3> of FIG. 7, when both the first classification number and the second classification number are natural numbers, the processor 120 may assign the second classification number to the target pixel and may replace the first classification number with the second classification number. At this time, the processor 120 may update the reference of the currently used classification number to the second classification number.

Referring to <B4> of FIG. 7, when the first classification number is not a natural number and the second classification number is a natural number, the processor 120 may assign the second classification number to the target pixel.

Hereinafter, assignment of classification numbers to the image data of FIG. 4 by applying the predetermined rules of FIGS. 6 and 7 will be described with reference to FIG. 4 and FIGS. 8 to 10. For convenience of description, an embodiment in which the processor 120 scans each of the pixels by using a raster scan method will be described as an example.

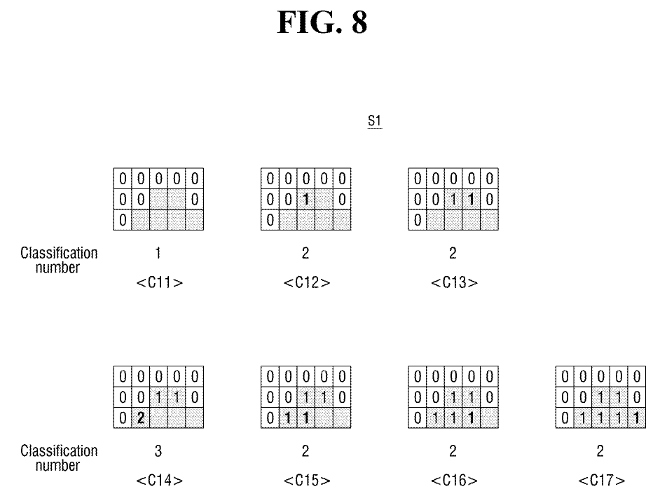

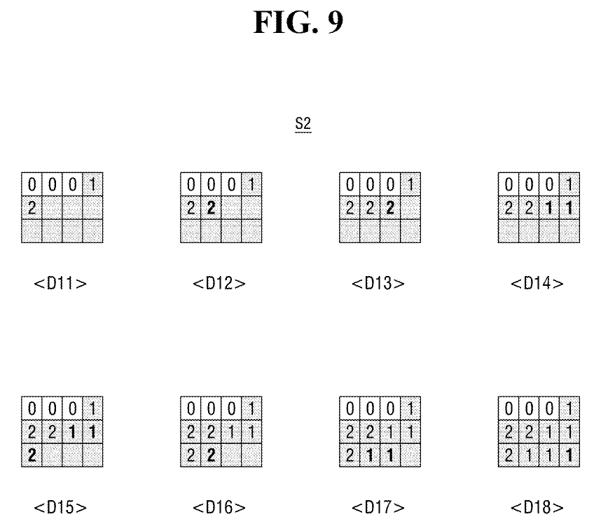

FIGS. 8 to 10 are views for describing classification numbers assigned to the thermal image of FIG. 4 according to the predetermined rules of FIGS. 6 and 7. FIG. 8 is a view for describing classification numbers assigned to a first partial region S1 of FIG. 4 according to the predetermined rules. FIG. 9 is a view for describing classification numbers assigned to a second partial region S2 of FIG. 4 according to the predetermined rules.

Referring to <C11> of FIG. 8, the processor 120 may assign classification numbers to pixels corresponding to the first case of the first partial region S1.

Based on a target pixel, since both a first classification number of a first pixel adjacent to a left side of the target pixel and a second classification number of a second pixel adjacent to an upper side of the target pixel are not natural numbers, the processor 120 may assign a classification number different from a currently used classification number to the target pixel.

For example, referring to <C11> of FIG. 8, since both the first classification number and the second classification number are 0, the processor 120 may assign a classification number different from the currently used classification number 0 to the target pixel. Accordingly, referring to <C12> of FIG. 8, the processor 120 may assign, as the classification number of the target pixel, a classification number 1 obtained by increasing the currently used classification number 0. The classification number different from the currently used classification number 0 may be a number obtained by increasing the currently used classification number 0; however, such description is merely exemplary, and embodiments of the present disclosure are not limited thereto.

Hereinafter, for convenience of description, an embodiment in which, when a classification number different from the currently used classification number is assigned to a target pixel according to the rule of <B1> of FIG. 6, a classification number obtained by increasing the currently used classification number is assigned to the target pixel will be described as an example.

Subsequently, referring to <C12> of FIG. 8, based on a subsequently scanned target pixel, the processor 120 may identify that a first classification number is 1 and a second classification number is 0, which is not a natural number. Accordingly, referring to <C13> of FIG. 8, the processor 120 may assign the first classification number 1 as a classification number of the target pixel according to the rule illustrated in <B2> of FIG. 6.

Based on a subsequently scanned target pixel, the processor 120 may identify that both a first classification number and a second classification number are not natural numbers. Accordingly, the processor 120 may assign a classification number different from a currently used classification number 1 to the target pixel according to the rule illustrated in <B1> of FIG. 6. For example, referring to <C14> of FIG. 8, since the currently used classification number is 1, the processor 120 may assign a classification number 2, which is different from the currently used classification number 1, to the target pixel.

Subsequently, based on a subsequently scanned target pixel, the processor 120 may identify that both a first classification number and a second classification number are natural numbers. Referring to <C14> of FIG. 8, the first classification number is 2 and the second classification number is 1. Accordingly, referring to <C15> of FIG. 8 together, the processor 120 may assign the second classification number 1 as the classification number of the target pixel according to the rule illustrated in <B3> of FIG. 7 and may replace the first classification number of the first pixel with the second classification number 1. That is, the first classification number of the first pixel may be changed from 2 to 1.

Subsequently, referring to <C15> of FIG. 8, based on a subsequently scanned target pixel, the processor 120 may identify that both the first classification number 1 and the second classification number 1 are natural numbers. Accordingly, referring to <C16> of FIG. 8 together, the processor 120 may assign the second classification number 1 as the classification number of the target pixel according to the rule illustrated in B3 of FIG. 7 and may replace the first classification number 1 of the first pixel with the second classification number 1. However, in this case, since the first classification number of the first pixel and the second classification number of the second pixel are identical, the processor 120 may maintain the first classification number 1 of the first pixel without replacing the first classification number 1 with the second classification number 1.

Subsequently, referring to <C16> of FIG. 8, based on a subsequently scanned target pixel, the processor 120 may identify that the first classification number 1 is a natural number and may identify that the second classification number 0 is not a natural number. Accordingly, referring to <C17> of FIG. 8 together, the processor 120 may assign the first classification number 1 as the classification number of the target pixel according to the rule illustrated in <B2> of FIG. 6.

Hereinafter, classification numbers assigned to the second partial region S2 of FIG. 4 will be described with reference to FIG. 4 and FIG. 9.

FIG. 9 is a view for describing classification numbers assigned to the second partial region S2 of FIG. 4 according to the predetermined rules.

Referring to <D11> of FIG. 9, based on a scanned target pixel, the processor 120 may identify that the first classification number 2 is a natural number and may identify that the second classification number 0 is not a natural number. Accordingly, referring to <D12> of FIG. 9 together, the processor 120 may assign the first classification number 2 as the classification number of the target pixel according to the rule illustrated in <B2> of FIG. 6.

Subsequently, referring to <D12> of FIG. 9, based on the scanned target pixel, the processor 120 may identify that the first classification number 2 is a natural number and may identify that the second classification number 0 is not a natural number. Accordingly, referring to <D13> of FIG. 9 together, the processor 120 may assign the first classification number 2 as the classification number of the target pixel according to the rule illustrated in <B2> of FIG. 6.

Referring to <D13> of FIG. 9, the processor 120 may identify that a first classification number 2 and a second classification number 1 are natural numbers based on a scanned target pixel. Accordingly, referring to <D14> of FIG. 9 together, the processor 120 may assign the second classification number 1 as the classification number of the target pixel according to the rule illustrated in <B3> of FIG. 7 and may replace the first classification number 2 of the first pixel with the second classification number 1.

Referring to FIG. 4 and <D14> of FIG. 9, the processor 120 may identify that a first classification number 2 and a second classification number 2 are natural numbers based on a scanned target pixel. Accordingly, referring to <D15> of FIG. 9 together, the processor 120 may assign the second classification number 2 as the classification number of the target pixel according to the rule illustrated in <B3> of FIG. 7. Since the first classification number 2 and the second classification number 2 are identical, the processor 120 may maintain the first classification number 1 of the first pixel without replacing the first classification number 1 with the second classification number 1.

Subsequently, referring to <D15> of FIG. 9, the processor 120 may identify that a first classification number 2 and a second classification number 2 are natural numbers based on a scanned target pixel. Accordingly, referring to <D16> of FIG. 9 together, the processor 120 may assign the second classification number 2 as the classification number of the target pixel according to the rule illustrated in <B3> of FIG. 7. Since the first classification number 2 and the second classification number 2 are identical, the processor 120 may maintain the first classification number 1 of the first pixel without replacing the first classification number 1 with the second classification number 1.

Subsequently, referring to <D16> of FIG. 9, the processor 120 may identify that a first classification number 2 and a second classification number 1 are natural numbers based on a scanned target pixel. Accordingly, referring to <D17> of FIG. 9 together, the processor 120 may assign the second classification number 1 as the classification number of the target pixel according to the rule illustrated in <B3> of FIG. 7. In addition, the processor 120 may replace the first classification number 2 of the first pixel with the second classification number 1 according to the rule illustrated in <B3> of FIG. 7.

Referring to <D17> of FIG. 9, the processor 120 may identify that a first classification number 1 and a second classification number 1 are natural numbers based on a scanned target pixel. Accordingly, referring to <D16> of FIG. 9 together, the processor 120 may assign the second classification number 1 as the classification number of the target pixel according to the rule illustrated in <B3> of FIG. 7. Since the first classification number 1 and the second classification number 1 are identical, the processor 120 may maintain the first classification number 1 of the first pixel without replacing the first classification number 1 with the second classification number 1.

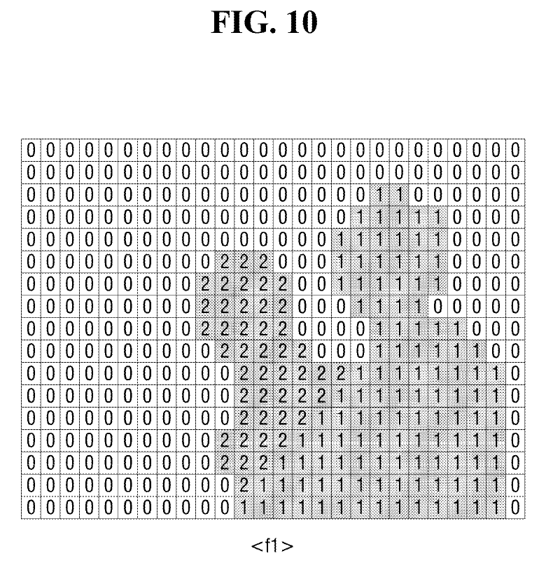

Referring to FIG. 10, FIG. 10 shows data in which the processor 120 assigns classification numbers to each pixel of the thermal image shown in FIG. 4 according to the predetermined rules illustrated in FIGS. 6 and 7.

Referring back to FIGS. 1 and 3, the processor 120 may calculate a total number of pixels for each classified pixel region by using the object identification module 123 loaded on the memory 130 and may recognize an object corresponding to a heat source based on the calculated total number of pixels and a preset object reference value (S300).

Hereinafter, a method of recognizing an object from data to which classification numbers are assigned will be described in detail with reference to FIGS. 11 and 12.

FIG. 11 is a view for describing object recognition of step S300 of FIG. 3. FIG. 12 is a view for describing an object reference value of step S330 of FIG. 11.

Referring to FIG. 11, the processor 120 may merge regions based on whether regions corresponding to respective classification numbers are adjacent to each other (S310). For example, when a first pixel region corresponding to a first classification number and a second pixel region corresponding to a second classification number are adjacent to each other, the processor 120 may merge the first pixel region and the second pixel region. Hereinafter, for convenience of description, a region having a classification number of 1 is defined as a first pixel region, and a region having a classification number of 2 is defined as a second pixel region.

Referring to FIG. 10 together, the processor 120 may identify that the first pixel region corresponding to the first classification number 1 and the second pixel region corresponding to the second classification number 2 are adjacent to each other. Accordingly, the processor 120 may merge the first pixel region and the second pixel region into one region.

Subsequently, the processor 120 may recognize an object corresponding to a heat source by calculating a total number of pixels included in the merged pixel region and comparing the calculated total number of pixels with a preset object reference value (S330). For example, the processor 120 may calculate a total number of pixels included in a region in which the first pixel region and the second pixel region are merged into one region. The processor 120 may identify an object corresponding to a heat source by comparing the calculated total number of pixels with the preset object reference value.

The preset object reference value may be a range of the number of pixels corresponding to each type of object. For example, the preset object reference value may include an adult reference value, a child reference value, and a pet reference value. However, this description is merely exemplary, and embodiments of the present disclosure are not limited thereto.

Referring to FIG. 12, the processor 120 may compare the calculated total number of pixels with an adult reference value (S331). For example, when the calculated total number of pixels is greater than the adult reference value, the processor 120 may recognize the corresponding pixel region as an adult object (S332).

Conversely, when the total number of pixels of the pixel region is less than the adult reference value, the processor 120 may compare the calculated total number of pixels with a child reference value (S333). For example, when the total number of pixels is less than the adult reference value and greater than the child reference value, the processor 120 may recognize the corresponding pixel region as a child object (S334).

In addition, when the total number of pixels of the pixel region is less than or equal to the child reference value, the processor 120 may determine non-existence for an object corresponding to the pixel region (S335). A step of recognizing an adult object and a child object by using the adult reference value and the child reference value is one embodiment, and such description is merely exemplary, and embodiments of the present disclosure are not limited thereto. In this case, the adult reference value and the child reference value may be numerical values for classifying an object based on at least one of dispersion and standard deviation of pixel distribution from a center of each pixel region. However, other methods for recognizing an adult object and a child object may also be applied.

Referring back to FIG. 3, the processor 120 may generate a control signal by using object information for the recognized object and sensing data (S400). The sensing data include data sensed in correspondence with a space imaged by the thermal image camera 200. For example, the sensing data may include space internal data including a temperature and humidity inside a space imaged by the thermal image camera 200 and environment data including an external temperature and external humidity of the space imaged by the thermal image camera 200.

When the thermal image camera 200 images an inside of a vehicle, the space internal data may include vehicle data for the inside of the vehicle. In this case, the vehicle data may further include, in addition to a temperature and humidity inside the vehicle, controlled state data of vehicle components. For example, the vehicle data may include whether the vehicle is in operation, whether a door is locked, and whether a heating and cooling device is in operation, and the like.

Hereinafter, an embodiment in which the control module generates a control signal will be described with reference to FIG. 13. The sensing data of the embodiment described below may include a temperature and humidity of a space and an external temperature and external humidity of the space.

FIG. 13 is a view for describing a first embodiment in which the control module of FIG. 1 operates step S400 of FIG. 3.

Referring to FIGS. 1 and 13, the processor 120 may recognize at least one object in the space in association with the object identification module 123 (S350).

Subsequently, the processor 120 may generate a control signal based on vehicle data of the sensing data. Here, the sensing data may include a temperature and humidity of the space and an external temperature and external humidity of the space. For example, the processor 120 may generate a first control signal for controlling a temperature and humidity of a space based on the sensing data and the number of objects of the recognized object information (S450). The space may be a space imaged by the thermal image camera 200.

The first control signal may be a control signal for reducing a difference between the temperature of the space and an external temperature. For example, when a difference between the external temperature and the temperature of the space is greater than a preset temperature range, the first control signal may be a signal for controlling the temperature of the space such that the difference between the temperature of the space and the external temperature is included within the preset temperature range.

Hereinafter, another embodiment in which the control module generates a control signal will be described with reference to FIG. 14. The sensing data of the embodiment described below may be vehicle data including a temperature, humidity, and oxygen concentration inside a vehicle, an external temperature and external humidity of the vehicle, and whether the vehicle is in operation and whether a door is locked.

FIG. 14 is a view for describing a second embodiment in which the control module of FIG. 1 operates step S400 of FIG. 3.

Referring to FIGS. 1 and 14, the processor 120 may recognize an object inside the vehicle (S360). Subsequently, the processor 120 may identify vehicle operation based on the sensing data (S461). For example, when an object is recognized inside the vehicle and the vehicle is in operation, the processor 120 may generate a second control signal for controlling operation of the vehicle based on the operation of the vehicle and object information of the recognized object (S462).

The second control signal may include a ventilation control signal for operating a vehicle ventilation system based on the number of recognized objects and an oxygen concentration inside a space. In addition, the second control signal may be a control signal for operating a heated seat arranged inside the vehicle when an external temperature is lower than a temperature inside the vehicle and the external temperature is lower than a preset minimum temperature. However, this description is merely exemplary, and embodiments of the present disclosure are not limited thereto.

In addition, when an object is recognized inside the vehicle but the vehicle is in a non-operating state, the processor 120 may identify whether a door of the vehicle is locked based on the sensing data (S463). When the door of the vehicle is in a locked state, the processor 120 may provide a notification indicating detection of an object to a pre-registered user terminal (S464). For example, the processor 120 may provide a notification indicating that a child inside a locked vehicle is left unattended to the pre-registered user terminal. In this case, the provided notification may include at least one of a temperature, humidity, and oxygen concentration of an internal space of the vehicle.

Conversely, when the door of the vehicle is in an open state, the processor 120 may generate a third control signal for performing an operation preset by a user. For example, the third control signal may be a signal for monitoring a change in sensing data for a preset waiting time and a signal for notifying the pre-registered user terminal of an open state of the door of the vehicle or playing an alarm sound. However, this description is merely exemplary, and embodiments of the present disclosure are not limited thereto.

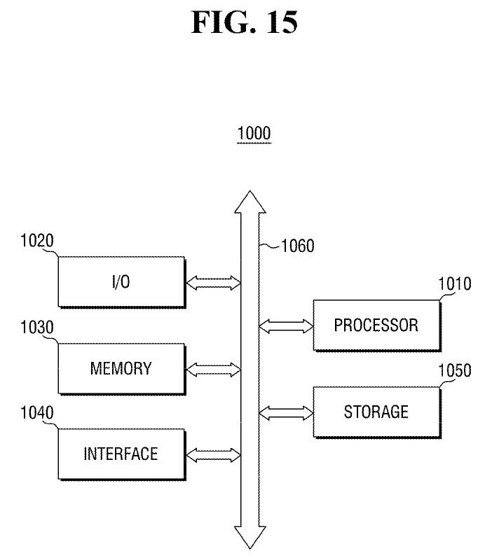

Hereinafter, a hardware implementation of a monitoring device that performs a monitoring method using a thermal image will be described with reference to FIG. 15.

FIG. 15 is a view for describing a hardware implementation of a monitoring device using a thermal image that performs a monitoring method using a thermal image according to some embodiments of the present disclosure.

Referring to FIG. 15, a monitoring device 100 that performs a monitoring method using a thermal image according to some embodiments of the present disclosure may be implemented as an electronic device 1000. The electronic device 1000 may include a processor 1010, an input/output device I/O 1020, a memory 1030, an interface 1040, a storage 1050, and a bus 1060. The processor 1010, the input/output device 1020, the memory 1030, the interface 1040, and/or the storage 1050 may be coupled to each other through the bus 1060. The bus 1060 corresponds to a path through which data are moved.

Specifically, the processor 1010 may include at least one of a central processing unit (CPU), a micro processor unit (MPU), a micro controller unit (MCU), a graphic processing unit (GPU), a microprocessor, a digital signal processor, a microcontroller, an application processor (AP), and logic elements capable of performing functions similar thereto.

The input/output device 1020 may include at least one of a keypad, a keyboard, a touch screen, and a display device.

The memory 1030 may load data and/or programs, or the like. In this case, the memory 1030 may be an operational memory for improving the operation of the processor 1010, and may include a high-speed DRAM and/or SRAM. The memory 1030 may include one or more volatile memory devices such as a double data rate static DRAM (DDR SDRAM) and a single data rate SDRAM (SDR SDRAM), and/or one or more nonvolatile memory devices such as an electrical erasable programmable ROM (EEPROM) and a flash memory.

The interface 1040 may perform a function of transmitting data to a communication network or receiving data from the communication network. The interface 1040 may be in a wired or wireless form. For example, the interface 1040 may include an antenna, a wired/wireless transceiver, or the like.

The storage 1050 may store and archive data and/or programs, or the like. The storage 1050 may include one or more nonvolatile memory devices such as a solid state drive (SSD), a hard drive, and a flash memory. In the present disclosure, the storage 1050 corresponds to a recording medium capable of storing a computer program composed of instructions for performing the above-described scoring method of a deep learning model.

An administrator terminal 200 may be applied to a personal digital assistant (PDA), a portable computer, a web tablet, a wireless phone, a mobile phone, a digital music player, a memory card, or any electronic product capable of transmitting and/or receiving information in a wireless environment.

Alternatively, the monitoring device 100 and the thermal image camera 200 according to embodiments of the present disclosure may each be a system formed by a plurality of electronic devices 1000 connected to each other through a network. In this case, each module or combination of modules may be implemented as the electronic device 1000. However, the present embodiment is not limited thereto.

Additionally, the monitoring device 100 may be implemented as at least one of a workstation, a data center, an internet data center (IDC), a direct attached storage (DAS) system, a storage area network (SAN) system, a network attached storage (NAS) system, and a redundant array of inexpensive disks or a redundant array of independent disks (RAID) system, but the present embodiment is not limited thereto.

In addition, the monitoring device 100 may transmit data to the thermal image camera 200 or an external device through a network. The network may include a network based on a wired internet technology, a wireless internet technology, and a short-range communication technology. The wired Internet technology may include at least one of, for example, a local area network (LAN) and a wide area network (WAN).

The wireless internet technology may include, for example, at least one of a wireless local area network (WLAN), Digital Living Network Alliance (DLNA), Wireless Broadband (WiBro), World Interoperability for Microwave Access (WiMAX), High Speed Downlink Packet Access (HSDPA), High Speed Uplink Packet Access (HSUPA), IEEE 802.16, Long Term Evolution (LTE), Long Term Evolution-Advanced (LTE-A), Wireless Mobile Broadband Service (WMBS), and 5G New Radio (NR). However, the present embodiment is not limited thereto.

For example, the short-range communication technology may include at least one of Bluetooth, Radio Frequency Identification (RFID), Infrared Data Association (IrDA), Ultra-Wideband (UWB), ZigBee, Near Field Communication (NFC), Ultra Sound Communication (USC), Visible Light Communication (VLC), Wi-Fi, Wi-Fi Direct, and 5G New Radio (NR). However, the present embodiment is not limited thereto.

The monitoring device 100 that communicates through a network may comply with technical standards and standard communication schemes for mobile communication. For example, the standard communication schemes may include at least one of Global System for Mobile communication (GSM), Enhanced Voice-Data Optimized or Enhanced Voice-Data Only (EV-DO), Wideband CDMA (WCDMA), High Speed Downlink Packet Access (HSDPA), High Speed Uplink Packet Access (HSUPA), Long Term Evolution (LTE), Long Term Evolution-Advanced (LTE-A), and 5G New Radio (NR). However, the present embodiment is not limited thereto.

Through this, a monitoring method using a thermal image and a device using the same according to embodiments of the present disclosure may secure safety of an object by optimizing a process of recognizing an object in a thermal image and generating a control signal based on real-time monitoring of the recognized object.

The above description is merely an example of the technical idea of the present embodiment, and those with ordinary knowledge in the technical field to which the present embodiment belongs may make various modifications and variations without departing from the essential characteristics of the present embodiment. Therefore, the present embodiments are not intended to limit the technical idea of the present embodiment, but rather to explain it, and the scope of the technical idea of the present embodiment is not limited by these embodiments. The scope of protection of this embodiment should be interpreted by the claims below, and all technical ideas within a scope equivalent thereto should be interpreted as being included in the scope of protection of this embodiment.

What is claimed is:

1. A monitoring method performed in a monitoring device using a thermal image generated by a thermal image camera, comprising:
determining, by the monitoring device, whether a pixel value of each pixel scanned in the thermal image is included in a preset reference range;
classifying, by the monitoring device, pixel regions by assigning a classification number to pixels included in the reference range according to a predetermined rule;
calculating, by the monitoring device, a total number of pixels for the classified pixel regions;
recognizing, by the monitoring device, an object for a heat source included in image data based on the total number of pixels and a preset object reference value; and
generating, by the monitoring device, a control signal by using object information of the recognized object and sensing data for a space imaged by the thermal image camera.

2. The monitoring method according to claim 1,
wherein the classifying the pixel regions includes:
assigning a natural number as a classification number to a pixel when a pixel value of each scanned pixel corresponds to a first case in which the pixel value is included in the preset reference range; and
assigning a classification number of “0” or a “null” value to a pixel when a pixel value of each scanned pixel corresponds to a second case in which the pixel value is not included in the preset reference range.

3. The monitoring method according to claim 2,
wherein the preset reference range includes an upper reference value and a lower reference value, and
wherein the classifying the pixel regions includes assigning a classification number to a pixel having a pixel value that is less than the upper reference value and greater than the lower reference value.

4. The monitoring method according to claim 2,
wherein the classifying the pixel regions includes:
when a target pixel to be scanned corresponds to the first case, assigning a classification number to the target pixel based on a first classification number of a first pixel adjacent to a left side of the target pixel and a second classification number of a second pixel adjacent to an upper side of the target pixel.

5. The monitoring method according to claim 4,
wherein the classifying the pixel regions includes:
when both the first classification number and the second classification number are natural numbers, assigning the second classification number to the target pixel and replacing the first classification number with the second classification number;
when the first classification number is not a natural number and the second classification number is a natural number, assigning the second classification number to the target pixel; and
when the first classification number is a natural number and the second classification number is not a natural number, assigning the first classification number to the target pixel.

6. The monitoring method according to claim 5,
further comprising the classifying the pixel regions:
when both the first classification number and the second classification number are not natural numbers, assigning a classification number different from a currently used classification number to the target pixel.

7. The monitoring method according to claim 1,
wherein the calculating the total number of pixels includes:
when a first pixel region to which a first classification number is assigned and a second pixel region to which a second classification number is assigned are adjacent to each other, merging the first pixel region and the second pixel region; and
recognizing an object for a heat source by calculating a total number of pixels included in the merged pixel region and comparing the calculated total number of pixels with a preset object reference value.

8. The monitoring method according to claim 1,
wherein the recognizing the object for the heat source includes:
recognizing the pixel region as an adult object when the total number of pixels for the pixel region is greater than a preset first reference value; and
recognizing the pixel region as a child object when the total number of pixels for the pixel region is less than the preset first reference value and greater than a second reference value different from the first reference value.

9. The monitoring method according to claim 8,
further comprising the recognizing the object for the heat source:
determining that an object corresponding to the pixel region is absent when the total number of pixels for the pixel region is less than the second reference value.

10. A monitoring device using a thermal image, comprising:
a processor;
a memory configured to load a computer program executed by the processor; and
an interface configured to exchange data generated during execution of the computer program with an external device,
wherein the computer program includes:
determining whether a pixel value of each pixel scanned in a thermal image received from a thermal image camera is included in a preset reference range;
classifying pixel regions by assigning a classification number to pixels included in the reference range according to a predetermined rule;
calculating a total number of pixels for the classified pixel regions;
recognizing an object for a heat source included in image data based on the total number of pixels and a preset object reference value; and
generating a control signal by using object information of the recognized object and sensing data for a space imaged by the thermal image camera.

11. The monitoring device according to claim 10,
wherein, in the computer program, the classifying the pixel regions includes:
assigning a natural number as a classification number to a pixel when a pixel value of each scanned pixel corresponds to a first case in which the pixel value is included in the preset reference range; and
assigning a classification number of “0” or a “null” value to a pixel when a pixel value of each scanned pixel corresponds to a second case in which the pixel value is not included in the preset reference range.

12. The monitoring device according to claim 11,
wherein, in the computer program, the classifying the pixel regions includes:
when a target pixel to be scanned corresponds to the first case, assigning a classification number to the target pixel based on a first classification number of a first pixel adjacent to a left side of the target pixel and a second classification number of a second pixel adjacent to an upper side of the target pixel.

13. The monitoring device according to claim 12,
wherein, in the computer program, the classifying the pixel regions includes:
when both the first classification number and the second classification number are natural numbers, assigning the second classification number to the target pixel and replacing the first classification number with the second classification number;
when the first classification number is not a natural number and the second classification number is a natural number, assigning the second classification number to the target pixel;
when the first classification number is a natural number and the second classification number is not a natural number, assigning the first classification number to the target pixel; and
when both the first classification number and the second classification number are not natural numbers, assigning a classification number different from a currently used classification number to the target pixel.

14. The monitoring device according to claim 10,
wherein the sensing data include a temperature and humidity of the space and an external temperature and external humidity of the space, and
wherein, in the computer program, the step of generating the control signal includes:
generating a first control signal for controlling the temperature and humidity of the space based on the number of objects of the object information and the sensing data.

15. The monitoring device according to claim 10,
wherein the thermal image camera is installed in a vehicle and images an inside of the vehicle,
wherein the sensing data include whether the vehicle is in operation and whether a door of the vehicle is locked, and
wherein, in the computer program, the step of generating the control signal includes:
identifying operation of the vehicle based on the sensing data and generating a second control signal for controlling operation of the vehicle based on the operation and the object information;
providing an object detection notification to a pre-registered user terminal by identifying a stopped state of the vehicle and a locked state of the door of the vehicle based on the sensing data; or
generating a third control signal for performing an operation preset by a user by identifying a stopped state of the vehicle and an open state of the door of the vehicle based on the sensing data.
